(19) United States
(12) Patent Application Publication
(10) Pub. No.: US 2024/0109446 A1
(43) Pub. Date: Apr. 4, 2024

(54) SOLAR CHARGING SYSTEM

(71) Applicant: TOYOTA JIDOSHA KABUSHIKI KAISHA, Toyota-shi (JP)

(72) Inventor: Yukinori MURAKAMI, Toyota-shi (JP)

(73) Assignee: TOYOTA JIDOSHA KABUSHIKI KAISHA, Toyota-shi (JP)

(21) Appl. No.: 18/357,228

(22) Filed: Jul. 24, 2023

(30) Foreign Application Priority Data
Oct. 4, 2022 (JP) 2022-160521

(51) Int. Cl. B60L 53/51; B60L 1/00; H02J 7/35

(52) U.S. Cl. CPC B60L 53/51; B60L 1/00; H02J 7/35; B60L 2210/10; H02J 2207/20

(57) ABSTRACT

A solar charging system mounted on a vehicle, comprising: a power generation module using a solar panel; an auxiliary battery storing electric power generated by the power generation module; an auxiliary load supplied with electric power from the auxiliary battery; a drive battery used for driving the vehicle; and a control unit provided between the drive battery and the auxiliary machine battery to control power transfer between both batteries, wherein when there is no electric current flowing into the auxiliary battery, the control unit supplies electric power other than electric power consumed by the auxiliary load to the drive battery among the electric power generated by the power generation module.

### CROSS-REFERENCE TO RELATED APPLICATION

This application claims priority to Japanese Patent Application No. 2022-160521 filed on Oct. 4, 2022, incorporated herein by reference in its entirety.

### BACKGROUND

### 1. Technical Field

The present disclosure relates to a solar charging system that controls supply of power generated by a solar panel mounted on a vehicle.

### 2. Description of Related Art

Japanese Unexamined Patent Application Publication No. 2021-083248 (JP 2021-083248 A) discloses a solar charging system in which, when a solar panel is in a state where power can be generated, power is supplied from the solar panel to an auxiliary system and power that is actually generated by the solar panel is derived, and when the actual generation power that is derived is equal to or more than a specified value, a drive battery is further charged by the power generated by the solar panel.

### SUMMARY

In the case of a system in which power generated by a solar panel is directly charged to an auxiliary battery without being stored in a dedicated power storage element, even when power of a specified value or more is generated by the solar panel, the charging efficiency of the power generated by the solar panel may be degraded depending on the state of the auxiliary battery to be charged. Therefore, there is a room for further study on a charging method of the power generated by the solar panel to be implemented in the solar charging system.

The present disclosure has been made in view of the above issue, and an object thereof is to provide a solar charging system capable of improving the charging efficiency of power generated by a solar panel.

In order to solve the above issue, according to an aspect of a technique of the present disclosure, a solar charging system mounted on a vehicle includes: a power generation module using a solar panel; an auxiliary battery that stores power generated by the power generation module; an auxiliary load to which power is supplied from the auxiliary battery; a drive battery used for driving the vehicle; and a control unit that is provided between the drive battery and the auxiliary battery and controls power transfer between the drive battery and the auxiliary battery. When no current flows into the auxiliary battery, the control unit supplies, to the drive battery, power other than power consumed by the auxiliary load, of the power generated by the power generation module.

According to the solar charging system of the present disclosure, the charging efficiency of the power generated by the solar panel can be improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram of a solar charging system and a peripheral portion thereof according to an embodiment of the present disclosure;

FIG. 2 is a processing flowchart of charge control executed by the solar charging system;

FIG. 3 is a diagram of a power path (solar power generation module→auxiliary load+drive battery); and

FIG. 4 is a diagram of a power path (solar power generation module→auxiliary battery+auxiliary load).

### DETAILED DESCRIPTION OF EMBODIMENTS

A solar charging system according to the present disclosure determines a supply destination (charging destination) of electric power generated by a solar power generation module based on a current flowing in and out of an auxiliary battery. Accordingly, the charging efficiency can be improved according to the state of the auxiliary battery regardless of the magnitude of the solar generated power.

Hereinafter, an embodiment of the present disclosure will be described in detail with reference to the drawings.

### Embodiment

### Configuration

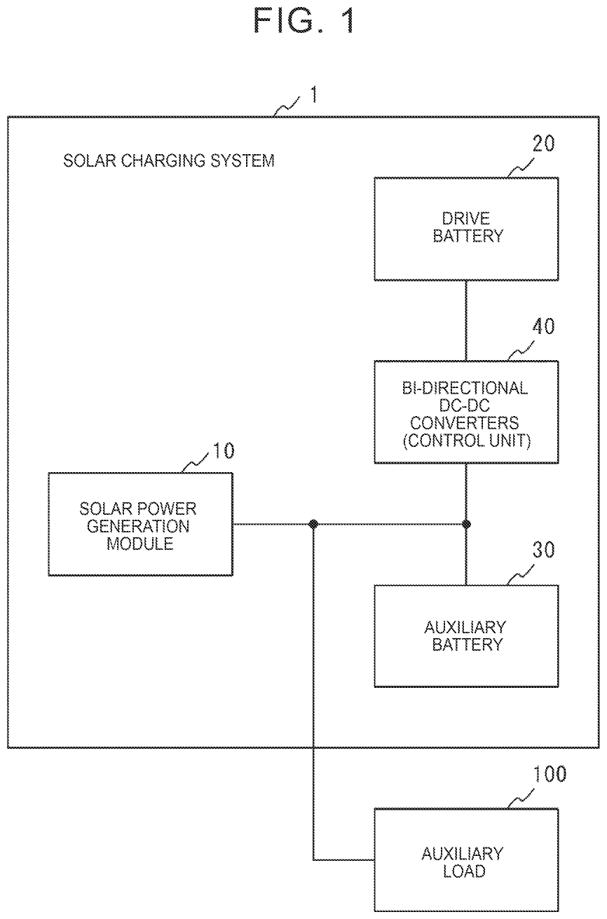

FIG. 1 is a block diagram illustrating a schematic configuration of a solar charging system 1 and a peripheral portion thereof according to an embodiment of the present disclosure. The solar charging system 1 illustrated in FIG. 1 includes a solar power generation module 10, a drive battery 20, an auxiliary battery 30, and bi-directional DC-DC converters 40. The solar charging system 1 is connected to an auxiliary load 100 so as to be capable of supplying electric power.

The solar charging system 1 may be mounted on vehicles such as hybrid electric vehicle (HEV), plug-in hybrid electric vehicle (PHEV), and battery electric vehicle (BEV.

The solar power generation module 10 is a power generation device that generates electric power by being irradiated with solar light, and outputs the generated electric power to the auxiliary battery 30, the auxiliary load 100, and the like connected to the solar power generation module 10. The solar power generation module 10 includes a solar panel that is an aggregate of solar cells, a solar DC-DC converter that outputs electric power generated by the solar panel at a predetermined voltage, a solar control unit that performs maximum-power-point tracking (MPPT) control, and the like (not shown). The generated electric power of the solar panel is calculated from a measured value of a sensor or a measuring instrument (not shown).

The drive battery 20 is a secondary battery configured to be chargeable and dischargeable, such as a lithium-ion battery or a nickel-metal hydride battery. The drive battery 20 is connected to a main device (not shown) for driving the vehicle, and can supply power necessary for the operation of the main device. Examples of the main equipment include a starter motor and a traveling electric motor. The drive battery 20 is connected to the solar power generation module 10 via the bi-directional DC-DC converters 40 so as to be charged by electric power generated in the solar panel of the solar power generation module 10. Further, the drive battery 20 is connected to the auxiliary battery 30 via the bi-directional DC-DC converters 40 so that the electric power stored in the auxiliary battery 30 can be charged. The drive battery 20 is a high-voltage battery having a higher rated voltage than the auxiliary battery 30.

The auxiliary battery 30 is a secondary battery configured to be chargeable and dischargeable, such as a lithium-ion battery or a lead-acid battery. The auxiliary battery can supply power necessary for the operation of the auxiliary load 100 to the auxiliary load 100. The auxiliary battery 30 is connected to the solar power generation module 10 so as to be able to be charged by electric power generated in the solar panel of the solar power generation module 10. The auxiliary battery 30 is also connected to the drive battery 20 via the bi-directional DC-DC converters 40 so as to be charged by the electric power stored in the drive battery 20. The charge amount (storage amount) of the auxiliary battery 30, the current flowing in and out of the auxiliary battery 30, and the like are monitored by a sensor, a measuring instrument, or the like (not shown).

The bidirectional DC-DC converter 40 is a bidirectional power converter capable of converting input power into predetermined-voltage power and outputting the converted power. The bidirectional DC-DC converters 40 have one end (referred to as the primary side) connected to the solar power generation module 10, the auxiliary battery 30, and the auxiliary load 100, and the other end (referred to as the secondary side) connected to the drive battery 20. The bidirectional DC-DC converters 40 can supply (pump-charge) the electric power outputted from the solar power generation module 10 and the auxiliary battery 30 connected to the primary side to the drive battery 20 connected to the secondary side. In addition, the bidirectional DC-DC converters 40 can supply (pump-out charge) the electric power of the drive battery 20 connected to the secondary side to the auxiliary battery and the auxiliary load 100 connected to the primary side. At the time of supplying the electric power, the bidirectional DC-DC converters 40 boost the voltage of the auxiliary battery 30 input to the primary side to obtain the output voltage of the secondary side (during the step-up operation), and step down the voltage of the drive battery 20 input to the secondary side to obtain the output voltage of the primary side (during the step-down operation). Instead of the bidirectional DC-DC converter 40, two unidirectional DC-DC converters may be provided in which the power transfer directions are reversed from each other.

The above-described bi-directional DC-DC converters 40 constitute a control unit that controls power transfer between the drive battery 20 and the auxiliary battery 30 together with an electronic control unit (not shown) that controls the converting operation. The control unit can acquire electric power generated by the solar panel of the solar power generation module 10 (solar generated electric power), the amount of electric power stored in the auxiliary battery 30, the current flowing in and out of the auxiliary battery 30, and the like. The control executed by the control unit will be described later. Note that the control unit may be provided as a configuration independent of the bidirectional DC-DC converters 40.

The auxiliary load 100 is a variety of auxiliary devices mounted on the vehicle. The auxiliary load 100 operates by receiving the power generated by the solar power generation module 10 and the power stored in the auxiliary battery 30. Examples of the auxiliary equipment include lighting equipment such as headlamps and indoor lamps, air conditioners such as heaters and air conditioners, and systems for autonomous driving and advanced driving support.

### Control

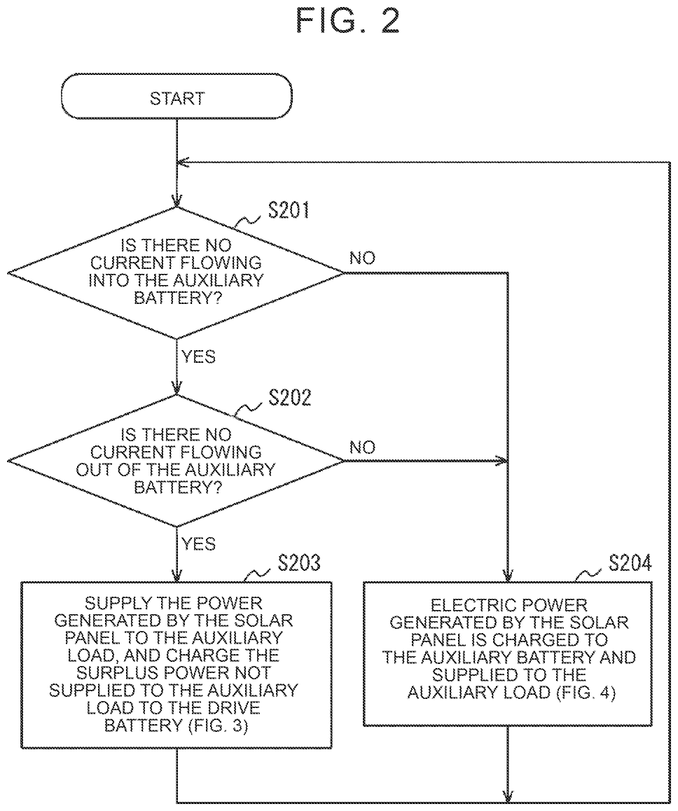

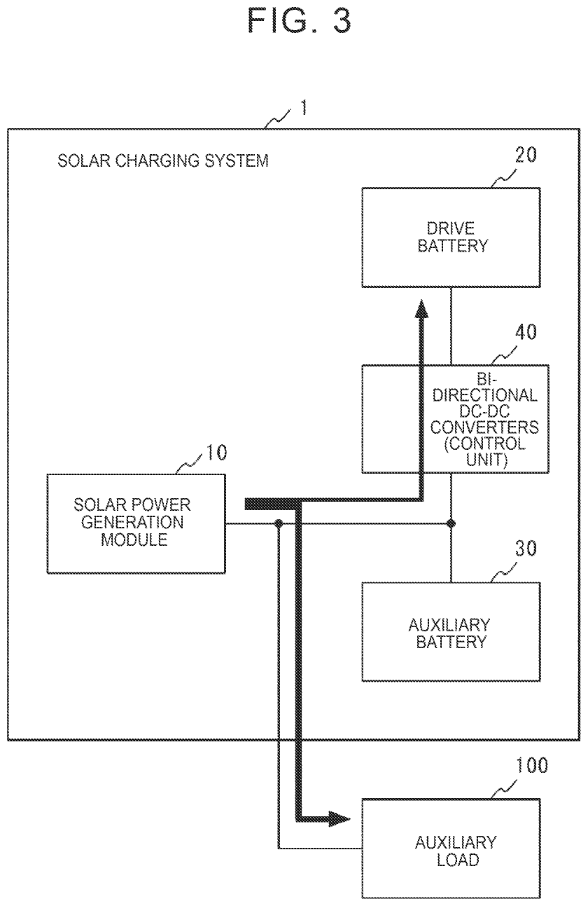

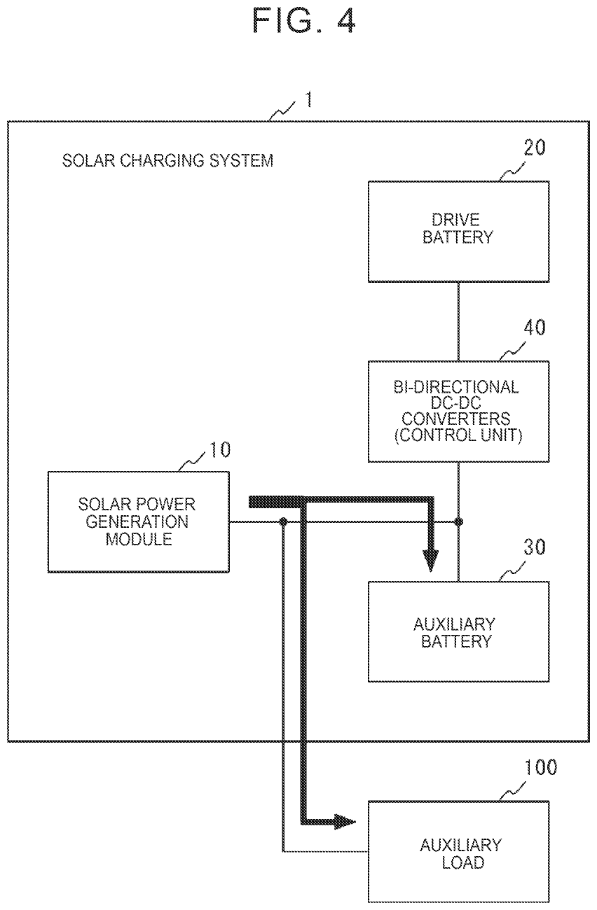

Next, with further reference to FIGS. 2, 3, and 4, the control performed in the solar charging system 1 according to the present embodiment will be described. FIG. 2 is a flowchart illustrating a procedure of charging control executed by the solar charging system 1. FIG. 3 is a diagram for explaining a state of power supply (charging) from the solar power generation module 10 to the auxiliary load 100 and the drive battery 20. FIG. 4 is a diagram for explaining a state of power supply (charging) from the solar power generation module 10 to the auxiliary battery 30 and the auxiliary load 100.

The charging control illustrated in FIG. 2 is repeatedly executed, for example, when the solar panel of the solar power generation module 10 generates electric power, until the solar panel does not generate electric power.

### S201

The solar charging system 1 determines whether or not there is a current flowing into the auxiliary battery 30 (whether or not it is zero). This determination is made in order to ascertain whether or not the auxiliary battery 30 is in a state of being chargeable. The source of the current flowing into the auxiliary battery 30 is typically the solar power generation module 10. If there is no current flowing into the auxiliary battery 30 when the source of the current is the solar power generation module 10, it can be determined that there is a margin in the electric power generated by the solar panel. Note that the source of the current includes a power supply system (for example, a backup power supply system) other than the drive battery 20 connected to the auxiliary battery 30.

If the solar charging system 1 determines that there is no current flowing into the auxiliary battery 30 (zero) (S201, Yes), the process proceeds to S202. On the other hand, when the solar charging system 1 determines that there is a current flowing into the auxiliary battery 30 (S201, No), the process proceeds to S204.

### S202

The solar charging system 1 determines whether or not there is a current flowing out of the auxiliary battery 30 (whether or not it is zero). This determination is made in order to ascertain whether power transfer (pumping charge) from the auxiliary battery 30 to the drive battery 20 is being performed. If the pumping charge is performed, it can be determined that the bidirectional DC-DC converters 40 are already performing the boost operation with high efficiency. In such cases, if the electric power generated by the solar panel is boosted and additionally supplied to the drive battery 20, the boosting efficiency of the bidirectional DC-DC converters 40 may be reduced.

If the solar charging system 1 determines that there is no current (zero) flowing out of the auxiliary battery 30 (S202, Yes), the process proceeds to S203. On the other hand, if the solar charging system 1 determines that there is a current flowing out of the auxiliary battery 30 (S202, No), the process proceeds to S204.

### S203

The solar charging system 1 supplies electric power generated by the solar panel of the solar power generation module 10 to the auxiliary load 100. Further, the solar charging system 1 outputs (charges) excess power (surplus power) that is not consumed by the auxiliary load 100 among the generated power of the solar panel to the drive battery 20 via the bidirectional DC-DC converters 40. The state of power supply from the solar power generation module 10 to the auxiliary load 100 and the drive battery 20 is as shown in FIG. 3.

When the solar charging system 1 supplies the generated power of the solar panel to the auxiliary load 100 and the surplus power is charged to the drive battery 20 based on the state of the auxiliary battery 30, the present charging control is ended.

### S204

The solar charging system 1 supplies (charges) the electric power generated by the solar panel of the solar power generation module 10 to the auxiliary battery 30 and supplies the electric power to the auxiliary load 100. The state of power supply from the solar power generation module 10 to the auxiliary battery 30 and the auxiliary load 100 is as shown in FIG. 4.

When the solar charging system 1 supplies the generated power of the solar panel to the auxiliary battery 30 and supplies the generated power to the auxiliary load 100 based on the state of the auxiliary battery 30, the present charging control ends.

### Operations and Effects

As described above, according to the solar charging system 1 according to the embodiment of the present disclosure, the auxiliary battery 30 is charged by the generated power of the solar power generation module 10 while there is a current flowing into the auxiliary battery 30, and the generated power of the solar power generation module 10 is supplied to the auxiliary load 100. Then, according to the solar charging system 1 of the present embodiment, when the current flowing into the auxiliary battery 30 disappears, the drive battery 20 is charged by the surplus electric power not consumed by the auxiliary load 100 while the generated electric power of the solar power generation module 10 is continuously supplied to the auxiliary load 100.

By this control, it is possible to determine that there is a margin in the power generation amount of the solar panel without using a control threshold value or the like, and thus it is possible to improve the charging efficiency of the electric power generated by the solar panel. Further, by this control, the number of times of performing the voltage conversion in the bidirectional DC-DC converter 40 can be minimized, so that power dissipation due to the voltage conversion can be reduced.

In the above-described embodiment, an example has been described in which it is determined whether or not there is a current flowing into the auxiliary battery 30 by the solar charging system 1, but the same control can be performed even if the charge amount (full charge state) of the auxiliary battery 30 is determined.

An embodiment of the present disclosure has been described above. However, the present disclosure can be regarded not only as a solar charging system, but also as a charging control method, a program of the method, a computer-readable non-transitory storage medium storing the program, a vehicle equipped with a solar charging system, and the like.

The solar charging system of the present disclosure can be used in a vehicle or the like on which a solar panel is mounted.

What is claimed is:

1. A solar charging system mounted on a vehicle, the solar charging system comprising:
a power generation module using a solar panel;
an auxiliary battery that stores power generated by the power generation module;
an auxiliary load to which power is supplied from the auxiliary battery;
a drive battery used for driving the vehicle; and
a control unit that is provided between the drive battery and the auxiliary battery and controls power transfer between the drive battery and the auxiliary battery, wherein when no current flows into the auxiliary battery, the control unit supplies, to the drive battery, power other than power consumed by the auxiliary load, of the power generated by the power generation module.

2. The solar charging system according to claim 1, wherein when current flows out of the auxiliary battery, the control unit does not supplies, to the drive battery, the power other than the power consumed by the auxiliary load, of the power generated by the power generation module.

3. The solar charging system according to claim 1, wherein the control unit includes a DC-DC converter that boosts power supplied from the power generation module and outputs the boosted power to the drive battery.
